(19) United States
(12) Patent Application Publication
(10) Pub. No.: US 2024/0106023 A1
(43) Pub. Date: Mar. 28, 2024

(54) CELL BUSBAR FUSE WITH DIRECT COOLING

(71) Applicant: Apple Inc., Cupertino, CA (US)

(72) Inventors: Abraham B. Caulk, Livermore, CA (US); Dylan Erb, San Jose, CA (US); Nivay Anandarajah, San Leandro, CA (US); Alexander Bartlett, San Jose, CA (US); David T. Rosenberg, Eugene, OR (US); Zhongying Shi, Sunnyvale, CA (US)

(21) Appl. No.: 18/104,274

(22) Filed: Jan. 31, 2023

Related U.S. Application Data
(60) Provisional application No. 63/376,495, filed on Sep. 21, 2022.

(51) Int. Cl. H01M 10/655; H01M 10/613; H01M 10/653; H01M 50/204; H01M 50/505

(52) U.S. Cl. CPC H01M 10/655; H01M 10/613; H01M 10/653; H01M 50/204; H01M 50/505

(57) ABSTRACT

A battery pack can include an enclosure with a first panel opposite and spaced apart from a second panel. First and second battery cell stacks can be positioned between the first and the second panels. Each of the first and the second battery cell stacks can include a plurality of interconnected battery cells. A busbar fuse can be electrically connected between the first and the second battery cell stack and can include an exterior thermal contact that is thermally connected to the first panel. A thermal interface material (TIM) can be disposed between the exterior thermal contact and the first panel where the first panel can form a portion of a heat exchanger. A shell can at least partially enclose the busbar fuse and can retain a potting compound or phase change material around the busbar fuse.

### CROSS-REFERENCE TO RELATED APPLICATION

This application claims the benefit of U.S. Patent Application Ser. No. 63/376,495, filed Sep. 21, 2022, the entire disclosure of which is hereby incorporated by reference in its entirety and for all purposes.

### BACKGROUND OF THE INVENTION

Battery packs can be used for many applications including supplying energy for an electric or hybrid vehicle. Structural battery packs can leverage the stiffness of the cells within the battery packs to increase the stiffness of the overall pack. Individual cells of the battery pack can be encased in sealed enclosures. The enclosures can be connected to the battery positive or negative potential which can increase the energy density of the cells within the battery pack, especially when the cell is long and thin with both terminals on one face. When the cell enclosures are connected to a potential of the battery, the cells may have an increased probability of experiencing an external short circuit resulting in damage to all or a portion of the battery pack.

### BRIEF SUMMARY OF THE INVENTION

A cell busbar fuse can be integrated with direct cooling that is tightly integrated with a cell stack to reduce the hazards that may result from a short circuit across the cell stack while minimizing any performance impacts during fast charging. Protecting against short circuits across a cell stack can be particularly important when considering a structural battery pack that could experience deformation during certain crash/abuse cases. The addition of direct cooling between the cell busbar fuse and the pack heat exchanger reduces or eliminates the temperature rise that would otherwise happen at the cell terminals during fast charge due to the increased electrical resistance (and resulting heat generation) of the fuse.

In various implementations, a battery pack can include an enclosure including a first panel opposite and spaced apart from a second panel. First and second battery cell stacks can be positioned between the first and the second panels. Each of the first and the second battery cell stacks can include a plurality of interconnected battery cells. A busbar fuse electrically connected between the first and the second battery cell stack and including an exterior thermal contact thermally connected to the first panel.

In various embodiments, a thermal interface material can be disposed between the exterior thermal contact and the first panel.

In various embodiments, the first panel can include a portion of a heat exchanger.

In various embodiments, the exterior thermal contact can be a first exterior thermal contact. The busbar fuse can include a second exterior thermal contact that is thermally connected to the first battery cell stack.

In various embodiments, the battery pack can include an enclosure that at least partially encloses the busbar fuse. The battery pack can also include a thermally conductive material disposed within the enclosure and thermally coupling the busbar fuse to the first battery cell stack.

### BRIEF DESCRIPTION OF THE DRAWINGS

FIG. 1 illustrates an exemplary battery system with cell busbar fuses;

FIG. 2 illustrates a cell busbar fuse of the exemplary battery system of FIG. 1;

FIG. 3 illustrates a perspective view of an exemplary cell busbar fuse;

FIG. 4 illustrates an exemplary view of the busbar fuse connected to a battery;

FIG. 5 illustrates an exemplary cell busbar fuse encased in a shell;

FIG. 6 illustrates a second exemplary cell busbar fuse.

FIG. 7 illustrates an exemplary process for manufacturing a cell busbar fuse.

### DETAILED DESCRIPTION OF THE INVENTION

In the following description, various embodiments will be described. For purposes of explanation, specific configurations and details are set forth to provide a thorough understanding of the embodiments. However, it will also be apparent to one skilled in the art that the embodiments may be practiced without the specific details. Furthermore, well-known features may be omitted or simplified in order not to obscure the embodiment being described.

Battery packs may include any number of battery cells packaged together to produce an amount of power. For example, many rechargeable batteries may include multiple cells having any number of designs including wound, stacked, prismatic, as well as other configurations. The individual cells may be coupled together in a variety of ways including series connections and parallel connections. As increased capacity is sought from smaller form factors, battery cell configurations and packaging may play an important role in operation of the battery system under normal operating conditions as well as during abuse conditions.

For example, cell damage may lead to short circuiting in some battery cell designs, which may cause temperature increases initiating exothermic reactions leading to thermal runaway. These events may generate temperatures of several hundred degrees over a period that may be seconds, minutes, or more depending on the size and capacity of the cell.

Integrating thermal fuses throughout the cell stack can lower the severity of the hazard that can result from an external short circuit across the entire cell stack (or a substack). However, thermal fuses can require a relatively large electrical resistance to open under short circuit conditions and the large electrical resistance can result in higher heat generation during circuit charge/discharge, such as during a DC fast charge. Battery packs can become thermally limited based on the hottest spot on any given cell to prevent excess aging.

The present technology overcomes these issues by incorporating cooling for the busbar fuses within the battery structure. In one example, a cell busbar fuse can be integrated with direct cooling to a heat exchanger that is tightly integrated with a cell stack to reduce the hazards that may result from a short circuit across the cell stack while minimizing any performance impacts during fast charging. Protecting against short circuits across a cell stack can be particularly important when considering a structural battery pack that could experience deformation during certain crash/abuse cases. The addition of direct cooling between the cell busbar fuse and the pack heat exchanger reduces or eliminates the temperature rise that would otherwise happen at the cell terminals during fast charge due to the increased electrical resistance (and resulting heat generation) of the fuse. In another example, a busbar fuse is thermally coupled to one or more battery enclosures to conduct heat to the batteries and to the heat exchanger. In another example, a busbar fuse is encased in a phase changing material that absorbs heat generated by the fuse. These and various other embodiments to reduce the temperature of busbar fuses within battery packs are described herein.

A battery pack can incorporate cell busbar fuses at various locations. The busbar fuses can be disposed across every cell, periodically (i.e., every 20 cells) or across entire cell stacks to lower the hazard resulting from any short circuits within the battery pack.

Although the remaining portions of the description will routinely reference lithium-ion or other rechargeable batteries, it will be readily understood by the skilled artisan that the technology is not so limited. The present techniques may be employed with any number of battery or energy storage devices, including other rechargeable and primary, or non-rechargeable, battery types, as well as electrochemical capacitors also known as supercapacitors or ultracapacitors. Moreover, the present technology may be applicable to batteries and energy storage devices used in any number of technologies that may include, without limitation, phones and mobile devices, handheld electronic devices, laptops and other computers, appliances, heavy machinery, transportation equipment including automobiles, water-faring vessels, air-travel equipment, and space-travel equipment, as well as any other device that may use batteries or benefit from the discussed designs. Accordingly, the disclosure and claims are not to be considered limited to any particular example discussed but can be utilized broadly with any number of devices that may exhibit some or all of the electrical or other characteristics of the discussed examples.

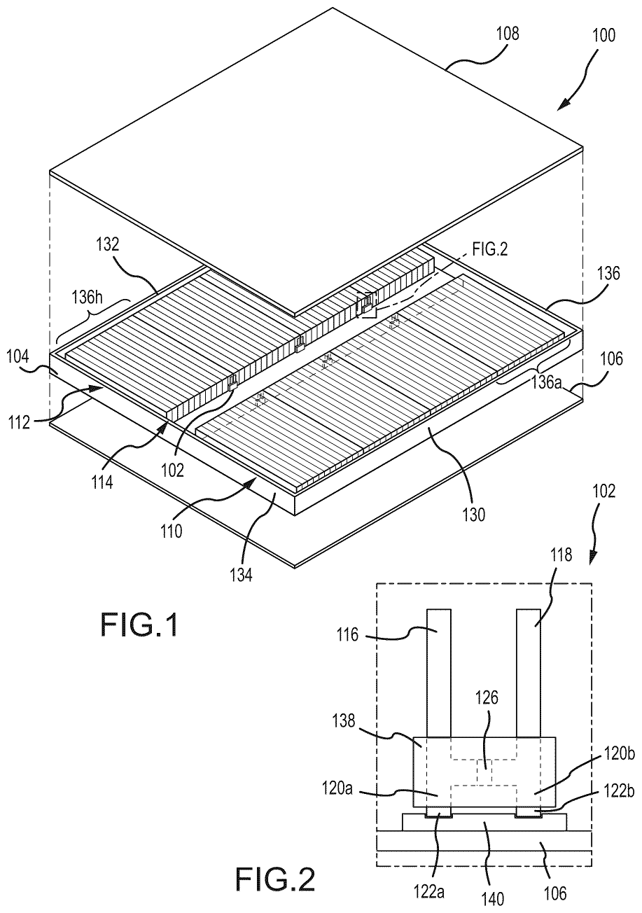

FIG. 1 illustrates an exemplary battery system 100 incorporating one or more cell busbar fuses 102. The battery system 100 can include an enclosure 104 including a first panel 106 opposite and spaced apart from a second panel 108. The enclosure 104 can include a first sidewall 130 opposite and spaced apart from a second sidewall 132, and can further include first lateral wall 134 and a second lateral wall 136, respectively, extending between the first and second sidewalls. Each of first and second sidewalls 130, 132, respectively, and first and second lateral walls, 134, 136, respectively, can be joined at the respective ends via welding, brazing, fasteners or other suitable technique.

A first battery cell stack 110 and second battery cell stack 112 can be positioned between the first panel 106 and the second panel 108. In some embodiments the first battery cell stack 110 and the second battery cell stack 112 can be high voltage cell stacks while in other embodiments they may be mid or low voltage cell stacks. Each of the first battery cell stack 110 and the second battery cell stack 112 can include a plurality of interconnected battery cells 114. First and second battery cell stacks 110, 112, respectively, can include one or more substacks 136a-136h that each include a smaller number of battery cells (e.g., 2, 5, 10, 20, 25, 30) than the respective battery cell stacks. In various embodiments, cell-to-cell busbars (not shown in FIG. 1) can connect adjacent cells in series or parallel and may be coupled to each cell via welds or other suitable techniques to the cell terminals. In some embodiments, a plastic carrier tray (not shown in FIG. 1) can hold and align busbars during the welding process and may retain the busbars. second panel 108.

One or more busbar fuses 102 can be electrically connected between one or more battery cells 114 within battery pack 100. In some embodiments busbar fuses 102 are connected between each substack 136a-136h, however in other embodiments they may be connected between each battery cell 114, or between each cell stack (e.g., 110, 112). Each busbar fuse 102 may include an exterior thermal contact (not shown in FIG. 1) that is thermally connected to the first panel 106 or the second panel 108 to conduct heat away from the busbar fuse, as described in more detail below.

FIG. 2 illustrates a simplified view of cell busbar fuse 102 shown in FIG. 1. The cell busbar fuse 102 can include a first terminal post 116 and a second terminal post 118. In various embodiments, the first terminal post 116 can be welded to a negative terminal of a battery cell and the second terminal post 118 can be welded to a positive terminal of an adjacent battery cell.

In some embodiments a fuse element 126 can electrically couple first terminal post 116 to second terminal post 118 such that all current flowing between adjacent battery cells flows through the fuse element. Fuse element 126 can be designed to break the electrical connection between first terminal post 116 and second terminal post 118 at a predetermined current. In some embodiments fuse element 126 can have a predetermined resistance and can be made from a particular metal that will melt at the predetermined current, severing the electrical connection. In various embodiments the predetermined resistance may generate heat during charging, in particular during fast charging when the current flowing between adjacent batteries is high, but not high enough to melt the fuse element 126.

In some embodiments busbar fuse 120 may include one or more internal busbars 120a, 120b that conduct heat from fuse element 126 to thermal feet 122a, 122b. Thermal feet 122a, 122b may be thermally coupled to first panel 106 that may form a portion of a heat exchanger that transfers thermal energy from battery pack 100 to the environment. In some embodiments a thermal interface material (TIM) 140 or other suitable material can be disposed between the thermal feet 122a, 122b and the first panel 106 to improve heat transfer from the thermal feet to the first panel 106. In various embodiments TIM 140 may be electrically insulative to provide electrical isolation between thermal feet 122a, 122b. In some embodiments TIM 140 may include an electrically insulative layer to provide electrical isolation between thermal feet 122a, 122b and first panel 106. In various embodiments thermal feet 122a, 122b may include a polyethylene terephthalate (PET) wrap, coating, enclosure, or other electrically insulative layer to electrically isolate the thermal feet from each other and first panel 106.

In some embodiments first terminal post 116 is formed from copper, a copper alloy or other suitable electrical conductor and is monolithically formed with busbar 120a and thermal foot 122a to efficiently conduct heat from fuse element 126. Similarly, second terminal post 118 may be formed from copper, a copper alloy or other suitable electrical conductor and is monolithically formed with busbar 120b and thermal foot 122b to efficiently conduct heat from fuse element 126. In some embodiments first and second terminal post 116, 118, internal busbars 120a, 120b and thermal feet 122a, 122b are all formed from a monolithic (e.g., continuous) electrical conductor and may be, for example, stamped out of a single sheet of metal. However, in other embodiments one or more of first and second terminal posts 116, 118, respectively, internal busbars 120a, 120b and thermal feet 122a, 122b can be formed from one or more different materials and electrically and thermally coupled to each other via welding, soldering, brazing or other suitable joining technique.

In some embodiments housing 138 is formed around first and second terminal posts 116, 118, respectively, internal busbars 120a, 120b and thermal feet 122a, 122b and can be made from an electrically insulative material. In various embodiments thermal feet 122a, 122b may extend from housing 130 a distance between 0 and 3 millimeters, a distance between 0.1 and 2 millimeter or distance between 0.5 and 1.5 millimeters. In other embodiments thermal feet 122a, 122b may be subflush (e.g., recessed) within housing 130.

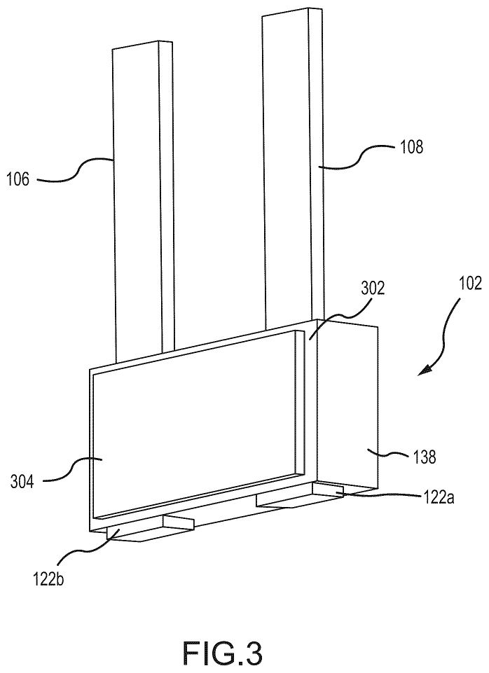

FIG. 3 illustrates a perspective rear isometric view of cell busbar fuse 102 that is shown in FIGS. 1 and 2. As shown in FIG. 3, back surface 302 of housing 138 may include a housing thermal interface material (TIM) 304. Housing TIM 304 may be used to thermally couple housing 138 to one or more battery cells 114 (see FIG. 1) to conduct heat from fuse element 126 (see FIG. 2) to battery cells 114 and to enclosure 104 (see FIG. 1).

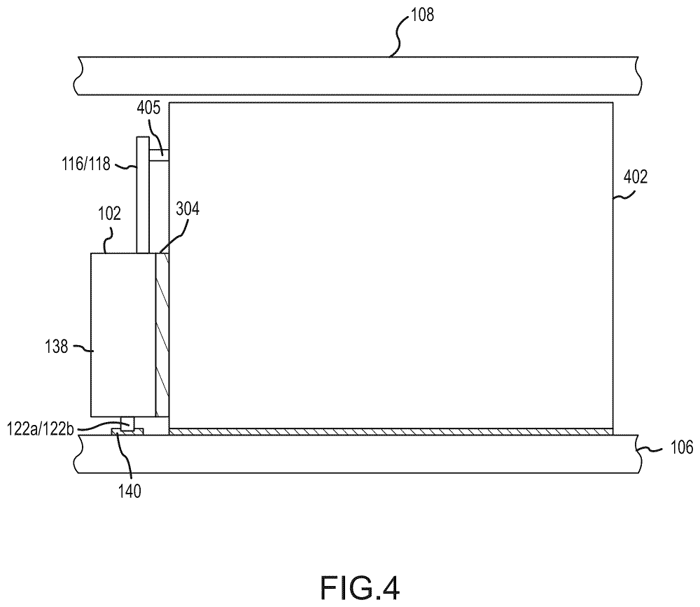

FIG. 4 illustrates a simplified partial cross-sectional view of battery pack 100 in the region of a busbar fuse 102, shown in FIG. 1. As shown in FIG. 4, busbar fuse 102 includes first and second terminal posts 116, 118, respectively, that are coupled to battery terminals 405 via welding, fasteners, or other suitable joining techniques. Busbar fuse 102 is thermally coupled to first panel 106 via thermal feet 122a, 122b and TIM 140. Busbar fuse 102 is also thermally coupled to battery cell 114 via housing TIM 304. In some embodiments both TIM 140 and housing TIM 304 can be used while in other embodiments either one or the other TIMs may be used. In various embodiments, thermal interface material 304 can be disposed on or around first and second terminal posts 116, 118, respectively. First panel 106 may form a portion of a heat exchanger that transfers thermal energy from battery pack 100 to the environment. A side panel of the first battery cell stack 402 is illustrated between the first panel 106 and the

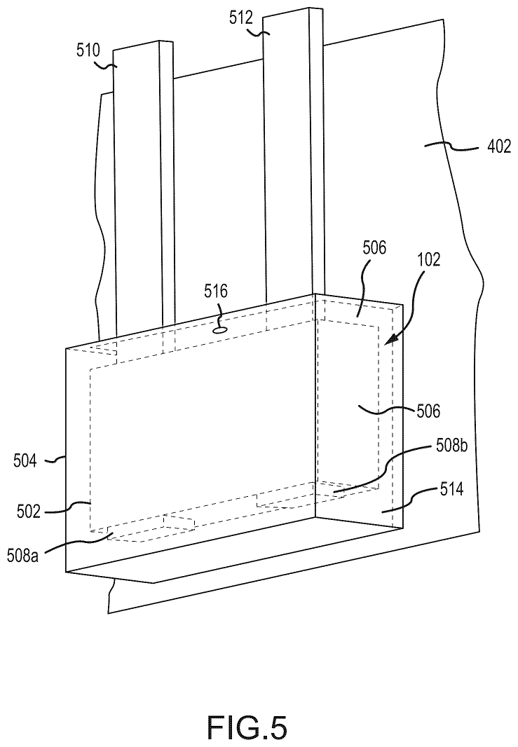

FIG. 5 illustrates an exemplary cell busbar fuse 502 that is at least partially encased in a shell 504. Cell busbar fuse 502 may be or include any of the components, features, or characteristics of any of the cell busbar fuses previously described, and the busbar fuse may be included in stacked batteries or energy storage devices as previously discussed. Cell busbar fuse 502 may be similar to cell busbar fuse 102 described in FIGS. 1-4, with like reference numbers referring to like features, however in this embodiment cell busbar fuse 502 may be configured to be encapsulated with a thermally conductive potting compound or phase change material, as described in more detail below. The bus bar fuse 502 can be affixed to a side panel 402 of the first battery cell stack 110.

Cell busbar fuse 502 may include a housing 506 from which thermal feet 508a, 508b extend and from which first and second terminal posts 510, 512, respectively, extend. Shell 504 can substantially surround a portion of busbar fuse 502 and may have a void 514 that inside the shell 504. In some embodiments shell 504 may be made from a plastic, polymer, or other suitable material. Shell 504 may have a fill port 516 that is used to inject thermally conductive potting compound within the shell 504 so the potting compound substantially encapsulates housing 506. In various embodiments, the potting compound can thermally couple the cell busbar fuse 502 to battery cell 114. The thermally conductive potting compound may be used to transfer heat from busbar fuse 502 to battery cell 114 which then transfers the heat to a heat exchanger. In some embodiments the thermally conductive potting compound may be electrically insulative and may include any suitable type of epoxy, glue or polymer and may be filled with one or more types of thermally conductive materials (e.g., particulates) such as but not limited to ceramic, diamond, or graphite etc.

In another embodiment, instead of injecting thermally conductive potting compound within shell 504 a phase change material (PCM) may be injected into the shell. PCMs absorb a large amount of latent heat during the process of transforming physical properties (e.g., changing from a solid to a liquid). In some embodiments the PCM may be electrically insulative and may include a paraffin wax, a modified wax, a polymers with long-chain molecules composed primarily of carbon and hydrogen or other suitable material.

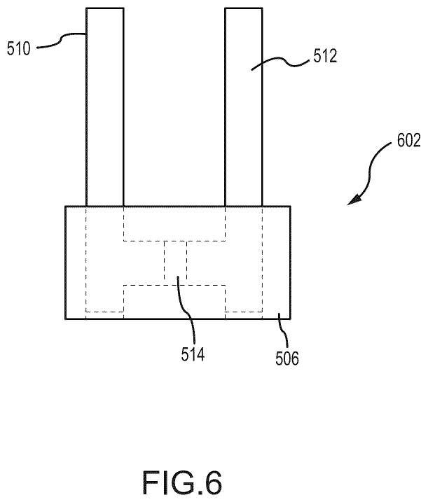

FIG. 6 illustrates an exemplary cell busbar fuse 602 that may be similar to cell busbar fuse 102 described in FIGS. 1-4, with like reference numbers referring to like features, however in this embodiment cell busbar fuse 602 does not have thermal feet. Cell busbar fuse 602 may be or include any of the components, features, or characteristics of any of the cell busbar fuses previously described, and the busbar fuse may be included in stacked batteries, shells or energy storage devices as previously discussed. More specifically, cell busbar fuse may be used as a replacement for cell busbar fuse 102 in FIGS. 1-4 and for cell busbar fuse 502 in FIG. 5.

Cell busbar fuse 602 may include a housing 506 from which first and second terminal posts 510, 512, respectively, extend. A fuse element 514 can electrically couple first terminal post 510 to second terminal post 512 such that all current flowing between adjacent battery cells flows through the fuse element. In some embodiments the lack of thermal feet (as compared to busbar fuses described in FIGS. 1-5) may provide electrical isolation at the bottom of housing 506 so that when used with a TIM (see e.g., TIM 140 in FIG. 2) an electrically conductive and thermally conductive TIM can be used which may have higher thermal conductivity than the electrically insulative counterparts. Similarly, when used with a shell (see e.g., shell 504 in FIG. 5) an electrically conductive and thermally conductive potting compound or phase change material can be used which may have higher thermal conductivity than the electrically insulative counterparts.

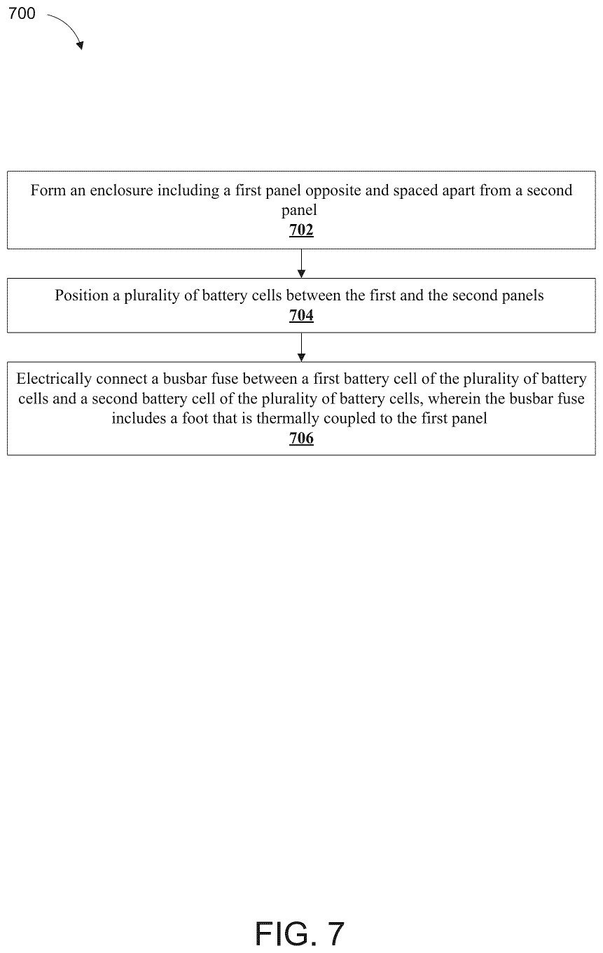

FIG. 7 is a flow chart of a process 700, according to an example of the present disclosure. According to an example, one or more process blocks of FIG. 7 may be performed by manufacturing process involving one or more industrial machines.

At block 705, process 700 may include forming an enclosure including a first panel opposite and spaced apart from a second panel. For example, manufacturing process may form an enclosure including a first panel opposite and spaced apart from a second panel, as described above.

At block 710, process 700 may include positioning a plurality of battery cells between the first and the second panels. For example, manufacturing process may position a plurality of battery cells between the first and the second panels, as described above.

At block 715, process 700 may include electrically connecting a busbar fuse between a first battery cell of the plurality of battery cells and a second battery cell of the plurality of battery cells, where the busbar fuse includes a foot that is thermally coupled to the first panel. For example, manufacturing process may electrically connect a busbar fuse between a first battery cell of the plurality of battery cells and a second battery cell of the plurality of battery cells, where the busbar fuse includes a foot that is thermally coupled to the first panel, as described above.

Process 700 may include additional implementations, such as any single implementation or any combination of implementations described below and/or in connection with one or more other processes described elsewhere herein. In various embodiments, the foot may include a metallic extension of a terminal post of the busbar fuse.

In various embodiments, process 700 further includes disposing a thermal interface material between the foot and the first panel.

In various embodiments, the first panel may include a portion of a heat exchanger.

In various embodiments, process 700 may include enclosing, at least partially the busbar fuse in a shell.

In various embodiments, process 700 further includes disposing a thermally conductive material within the shell; and thermally coupling the busbar fuse to the first battery cell.

In various embodiments, process 700 further includes disposing a phase changing material around the busbar fuse within the shell.

In various embodiments, the phase changing material is electrically isolative.

It should be noted that while FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of these particular embodiments can be combined in any suitable manner without departing from the spirit and scope of embodiments of the disclosure.

Additionally, spatially relative terms, such as “bottom or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

What is claimed is:

1. A battery pack, comprising:
an enclosure including a first panel opposite and spaced apart from a second panel;
a plurality of battery cells positioned between the first and the second panels; and
a busbar fuse electrically connected between a first battery cell of the plurality of battery cells and a second battery cell of the plurality of battery cells, wherein the busbar fuse includes a foot that is thermally coupled to the first panel.

2. The battery pack of claim 1 wherein the foot comprises a metallic extension of a terminal post of the busbar fuse.

3. The battery pack of claim 1 further comprising a thermal interface material disposed between the foot and the first panel.

4. The battery pack of claim 1 wherein the first panel comprises a portion of a heat exchanger.

5. The battery pack of claim 1 further comprising a shell that at least partially encloses the busbar fuse; and
a thermally conductive material disposed within the shell and thermally coupling the busbar fuse to the first battery cell.

6. The battery pack of claim 5, further comprising a phase changing material surrounding the busbar fuse disposed within the shell.

7. An electrical power pack, comprising:
an enclosure including a first panel opposite and spaced apart from a second panel;
a plurality of battery cells positioned between the first and the second panels; and
a busbar fuse electrically connected between a first battery cell of the plurality of battery cells and a second battery cell of the plurality of battery cells, wherein the busbar fuse includes a foot that is thermally coupled to the first panel.

8. The electrical power pack of claim 1, wherein the foot comprises a metallic extension of a terminal post of the busbar fuse.

9. The electrical power pack of claim 1, further comprising a thermal interface material disposed between the foot and the first panel.

10. The electrical power pack of claim 1, wherein the first panel comprises a portion of a heat exchanger.

11. The electrical power pack of claim 1, further comprising:
a shell that at least partially encloses the busbar fuse; and
a thermally conductive material disposed within the shell and thermally coupling the busbar fuse to the first battery cell.

12. The electrical power pack of claim 11, further comprising a phase changing material surrounding the busbar fuse disposed within the shell.

13. A method for constructing a battery pack:
forming an enclosure including a first panel opposite and spaced apart from a second panel;
positioning a plurality of battery cells between the first and the second panels; and
electrically connecting a busbar fuse between a first battery cell of the plurality of battery cells and a second battery cell of the plurality of battery cells, wherein the busbar fuse includes a foot that is thermally coupled to the first panel.

14. The method of claim 13, wherein the foot comprises a metallic extension of a terminal post of the busbar fuse.

15. The method of claim 13, further comprising:
disposing a thermal interface material between the foot and the first panel.

16. The method of claim 13, wherein the first panel comprises a portion of a heat exchanger.

17. The method of claim 13, further comprising enclosing, at least partially the busbar fuse in a shell.

18. The method of claim 17, further comprising:
disposing a thermally conductive material within the shell; and
thermally coupling the busbar fuse to the first battery cell.

19. The method of claim 17, further comprising:
disposing a phase changing material around the busbar fuse within the shell.

20. The method of claim 19, wherein the phase changing material is electrically isolative.
